(19) United States
(12) Patent Application Publication
(10) Pub. No.: US 2002/0042857 A1
(43) Pub. Date: Apr. 11, 2002

(54) Industrial multi-port data connector system

(76) Inventors: Nicolas D.L. Jones, Kitchener (CA); Steve E. Blakely, Waterloo (CA); Bradley G. Woodman, Evanston, IL (US)

Correspondence Address: James J. Hill Esq., Ste. 3000, 300 S. Wacker Dr., Chicago, IL, 60606, US

(21) Appl. No.: 09/970,595

(22) Filed: Oct. 4, 2001

Related U.S. Application Data
(60) Provisional application No. 60/237,982, filed on Oct. 5, 2000.

(51) Int. Cl. G06F 13/00

(52) U.S. Cl. 710/300

(57) ABSTRACT

A multi-port electrical connector system suitable for use in an industrial environment includes a plurality of quick change serial data signal connectors mounted to a rigid insulating casing. In addition, an industrial power connector and an industrial parallel data connector are mounted to the casing. Stored within the housing is a controller including a microprocessor and associated firmware for storing and routing signals and a media access controller for interfacing the microprocessor with the associated physical layer interface.

### RELATED APPLICATION

This application claims priority benefit under 35 U.S.C. §120 of co-pending Provisional application No. 60/237,982 filed Oct. 5, 2000 for “Industrial Ethernet Multi-Port Connector System”.

### FIELD OF THE INVENTION

The present invention relates to industrial communication networks in general; and in particular, it relates to a multiple-port data interconnect system with a programmed controller suitable for interface between a parallel data network and individual serial data ports which are part of a serial data communication network of the type in widespread use in the manufacturing automation industry.

### BACKGROUND OF THE INVENTION

The manufacturing automation industry relies heavily on the use of programmable logic controllers or programmed micro controllers, as they are sometimes called, the center of which is a programmable digital computer or central processor unit (CPU), programmed to perform control, maintenance and surveillance functions in industrial/manufacturing environments. Typically, industrial communication networks use serial data transmission techniques to transmit and receive data at the central processor from remote machines or devices. There has been a substantial and steady increase in data traffic in such communication/control systems. Perhaps equally important, there is a desire to integrate elements of the larger industrial/manufacturing environment, namely, functions performed in the office, into a more integrated network that would allow, for example, engineering, accounting and purchasing departments to communicate with manufacturing areas, and vice versa, in a common communication network. A problem arises in that many office environments operate on parallel data networks using known protocols such as Ethernet IP®, ProfiNet, ModBus, ITCP, SMTP (e-mail) or HTML (hypertext markup language) layered on top of the TPC/IP suite. Normally, parallel data connectors for such parallel data networks are not suited for the rigorous environment of the manufacturing areas.

One such network widely used in office and commercial environments is the Ethernet network having a widely known and used operation protocol and the ability to expand through the use of local area networks (LANs). Thus, there is a desire to provide existing serial-data industrial automation manufacturing systems with a parallel input/output (I/O) communication port which can withstand the rigors of a manufacturing environment. This must be done, of course, in such a manner as to permit independent operation of the different systems and networks being interfaced, so it is desirable to include a programmed processor in the device.

### SUMMARY OF THE INVENTION

The present invention provides a multiple-port electrical connector system suitable for use in an industrial environment and capable of interfacing with a parallel data network such as Ethernet or any other parallel data network suited for use in a manufacturing or other industrial facility. A sturdy, rigid plastic casing supports a plurality of connectors partially embedded in epoxy with all connectors accessible from a common direction, thus enabling the casing to be mounted to a surface, such as on an equipment cabinet.

The connectors include a plurality of industrial circular quick-disconnect serial data signal connectors, an industrial power connector, an industrial parallel data connector. Housed within the casing is a master controller including a programmable microprocessor and associated firmware for storing and routing signals, and a media access controller (MAC) for interfacing the microprocessor with the parallel data physical layer interface (PHY) which provides an interface to the specific media (e.g. Ethernet) being employed (e.g., 10 base/T or 100 base/T). The disclosed embodiment includes an industrial parallel connector suited for use with Ethernet applications, but persons skilled in this art will recognize that other parallel data connectors may equally well be substituted, with appropriate program changes.

Other features and advantages of the present invention will be apparent to persons skilled in the art from the following detailed disclosure of the exemplary embodiment accompanied by the attached drawing where identical reference numerals will refer to like elements in the various views.

### BRIEF DESCRIPTION OF THE DRAWING

FIG. 1 is a top view of an industrial multiple-port data interconnect system constructed according to the present invention;

FIG. 2 is a side elevational view of the interconnect system of FIG. 1;

FIG. 3 is a front or upper perspective view of a receptacle or collet for a commercial Ethernet connector;

FIG. 4 is a top elevation view of the data connector receptacle of FIG. 3;

FIG. 5 is a side elevation view of the receptacle of FIG. 3;

FIG. 6 is a side view of a nut received on the receptacle;

FIG. 7 is a cross-sectional view of the collet taken through the sight line 7-7 of FIG. 4;

FIG. 8 is a section view taken through the sight line 8-8 of FIG. 4;

FIG. 9 is a frontal view of the commercial Ethernet connector of the interconnect system of FIG. 1;

FIG. 10 is a side view of the Ethernet connector of FIG. 9;

FIG. 11 is a top partial view of a quick disconnect power connector mounted to an associated printed circuit board;

FIG. 12 is a side view of the power connector of FIG. 11;

FIG. 13 is a functional block diagram of one embodiment of the master controller for the multiple-port data network interconnect system of FIG. 1;

FIG. 14 is a functional block diagram of an alternate embodiment of a master controller for an Ethernet interconnect system of FIG. 1; and

FIG. 15 is a functional diagram of the software and firmware for the master controller.

### DETAILED DESCRIPTION OF THE ILLUSTRATED EMBODIMENT

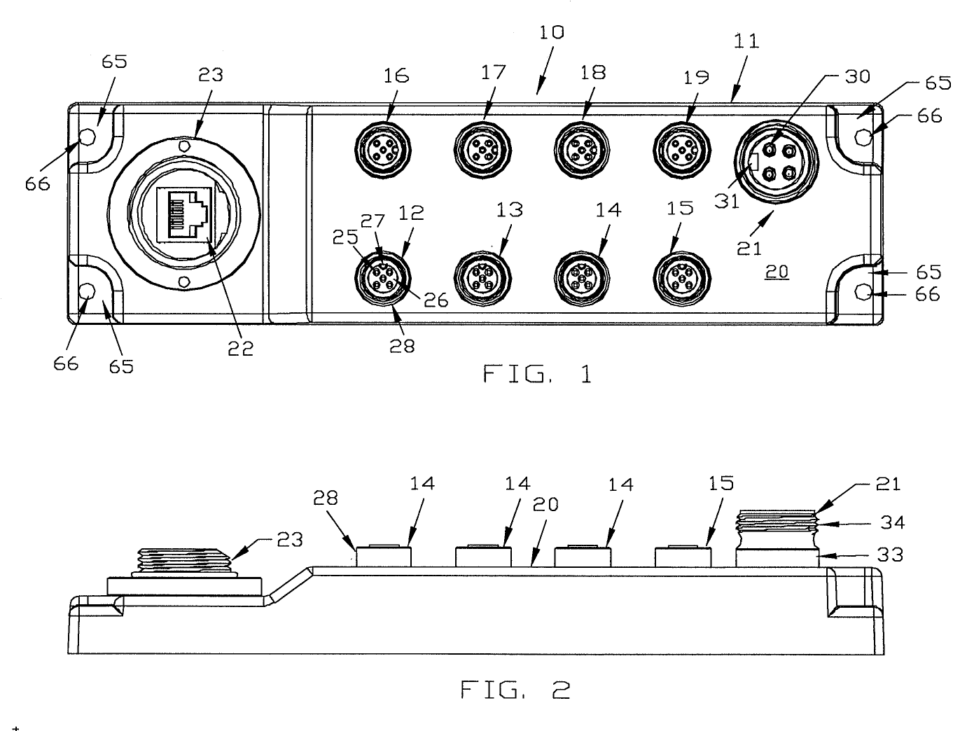

Referring first to FIG. 1, reference numeral 10 generally designates a multiple-port data interconnect system including a rigid housing or casing 11, a plurality of individual circular quick-disconnect serial data signal connectors 12-19, a circular quick-disconnect power connector 21, and an industrial parallel data connector generally designated 23. Casing 11 may be formed of PBT plastic. In the illustrated embodiment, the parallel data connector 23 includes a conventional commercial RJ45 connector 22 of the type widely used in Ethernet networks. Other parallel data connectors, used for different parallel networks and data protocols, may equally well be used, as mentioned above.

Each of the quick-disconnect serial data signal connectors 12-19 may be identical so that only one need be described further for full understanding of the invention. The connectors 12-19 maybe conventional female electrical connectors of a type similar to that sold under the trademark MICRO-CHANGE® by Woodhead Industries Inc., of Northbrook, Ill. The serial data connectors 12-19 in the illustrated embodiment are shown as five-pole female connectors having five separate connector elements in the form of sockets, such as the socket designated 25 associated with connector 12, although, only four poles may be used, if desired.

Two lines or connector elements are commonly used for data and two are used for providing DC power, if necessary. The fifth connector element, if used may be a system common. Each of the connectors 12-19 is of the type used in PLC manufacturing systems for connecting either to sensors such as limit switches or proximity switches, or to actuating devices such as solenoids or the like which are widely used in the manufacturing automation industry, as persons skilled in the art will readily appreciate. The connector 12 includes an insulating insert 26 for securing the female connecting elements or sockets 25, and the insert 26 defines a slot 27 for keying a mating male serial data connector. In addition, the connector 12 includes an internally threaded collar 28 which also is designed to receive a corresponding externally threaded member of a mating male connector, as is known in the art.

It will be observed that the connectors 12-19 are circular in section; and this is characteristic of such industrial quick disconnect connectors because it facilitates incorporating a positive mechanical coupling, either by threading or through interface or other mechanical structure. It is considered advantageous to include some such mechanical coupling in all the connectors, including the quick disconnect power connector 21 and the industrial parallel data connector 23 because of the possibility that a worker might inadvertently contact one of the mating connectors (not shown) and interrupt the connection, as well as to reduce any tendency to uncouple the mating connectors by vibration since the housing 11 many be mounted to a machine or to a metal cabinet or panel. Such circumstances are possible in many industrial and manufacturing environments.

In the illustrated embodiment, four of the quick disconnect serial data signal connectors 12-19 may be used for connections to sensing devices which transmit data signals back to the interconnect system and, and four connectors may be used for connecting to control devices such as solenoids or actuators so that signals are sent from the interconnect system to the remote devices. The two applications (sensing devices and control devices) may be color-coded for the user, as will be described. Other arrangements or combinations are possible.

Serial data signal connectors associated with control devices such as solenoids, actuators and visual indicators are referred to as “output” serial data connectors because information is being transmitted to the actuators. In the illustrated embodiment of FIG. 1, connectors 16-19 may be output connectors, and the inserts associated with the output connectors may have one color, such as black. Connectors 12-15 may be associated with sensors such as photo sensors and proximity sensors or limit switches, and these connectors are referred to as “input” serial data connectors because information is being transmitted from the sensors to the interconnect system. The inserts associated with the input connectors 12-15 may have a distinctly different color, such as yellow, thus providing the user with a clear visual distinction between input and output data signal connectors.

The serial data signal connectors 12-19 identified are suitable for use in an industrial environment and have been used in the manufacturing automation industry successfully for many years. As used herein, the term “circular quick disconnect serial data connector” is intended to refer to the data signal connectors 12-19 which have been disclosed and other, functionally interchangeable connectors which are also suitable for use in the manufacturing automation industry, as described, typically the female connectors have internal threads for achieving a stable mechanical interconnection with the mating male connectors and include a structure or mechanism for positively coupling to a corresponding, mating male connector, either through a threaded connection, friction or other equivalent coupling mechanism.

Turning now to the power connector 21, it also may be one of a type of industrial circular quick disconnect power connectors widely used in the manufacturing automation industry and available from Woodhead Industries, Inc. under the trademark MINI-CHANGE®. In the illustrated embodiment (FIGS. 1, 2, 11 and 12), the quick disconnect power connector 21 is a male connector including four poles in the form of pins, such as the pin designated 30, and a key 31 for fitting into a corresponding way of a female circular quick disconnect power connector. Although four pins are shown for the connector 21 in FIG. 1, typically only two pins are used for power since most manufacturing automation systems employ digital controllers requiring 24 volts DC for operation. Connector 21 includes an upright exterior wall forming a collar and designated 33 in FIG. 2, the upper portion of which is externally threaded at 34, making it a male circular quick disconnect power connector.

Turning now to FIGS. 11 and 12, the industrial quick disconnect power connector 21 is shown mounted on a printed circuit board 68 which is conventionally mounted or embedded by epoxy within the housing 11. In addition to the connector 35, a bi-color LED 69 if mounted on the board 68. When the LED 69 is illuminated in one color (red, for example)it indicates that DC power is not being supplied to the system due to a polarity reversal, and when the LED 69 is illuminated in a second color (green for example) it indicates that DC power (24 v. DC) is being supplied to the system with proper polarity. The LED 69 if used, may be located on the upper surface of the switch housing 11, adjacent the industrial quick disconnector power connector 21, but is not seen in FIG. 1.

The industrial quick disconnect power connector 21 is commercially available under the trademark MINI-CHANGE® from Daniel Woodhead Company, Northbrook, Ill., and it includes an outer metallic sheath 71 (34 in FIG. 2), which defines a peripheral groove 72 for receiving an O-ring 73 which seals against the cylindrical wall of a receiving aperture formed in the top wall of the housing 11. Sheath 71 also includes a cylindrical portion above the groove 72 and designated 74 for being pressfit into the upper wall 20 of the casing 11. The upper portion of the sheath 71 is externally threaded at 34, as mentioned. An insert 76 of non-conducting rigid plastic material is received within the sheath 71. A plurality (four) of connector elements, one pair of which is designated 77 and the other pair of which is designated 78 in FIG. 11 are mounted in the insulating insert 76. The connector elements 77 are for coupling primary power to the PLC system and the local area network with which it is associated. The connector elements 78 are designated as auxiliary power connecting elements, as is know in the art.

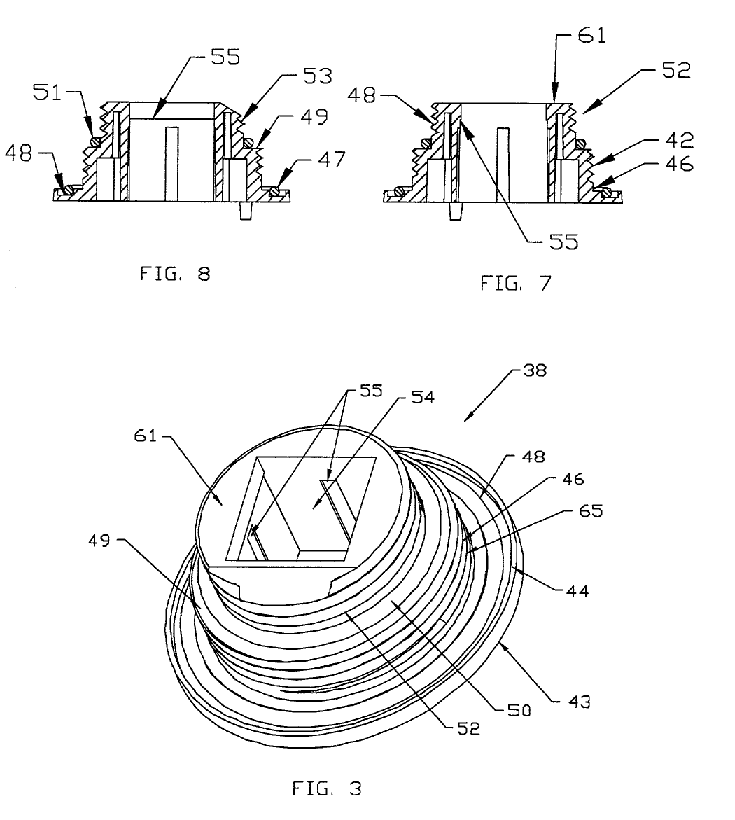

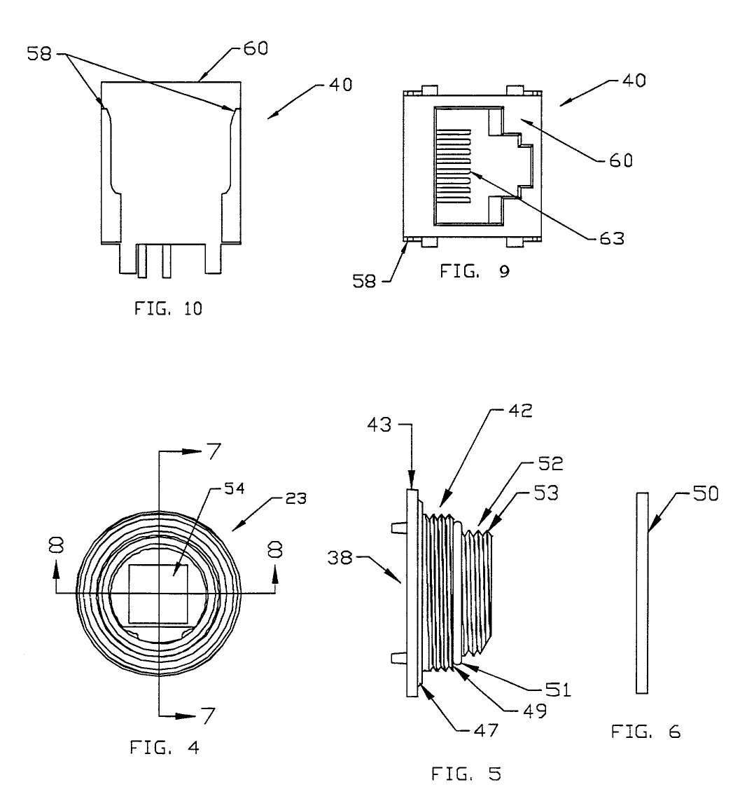

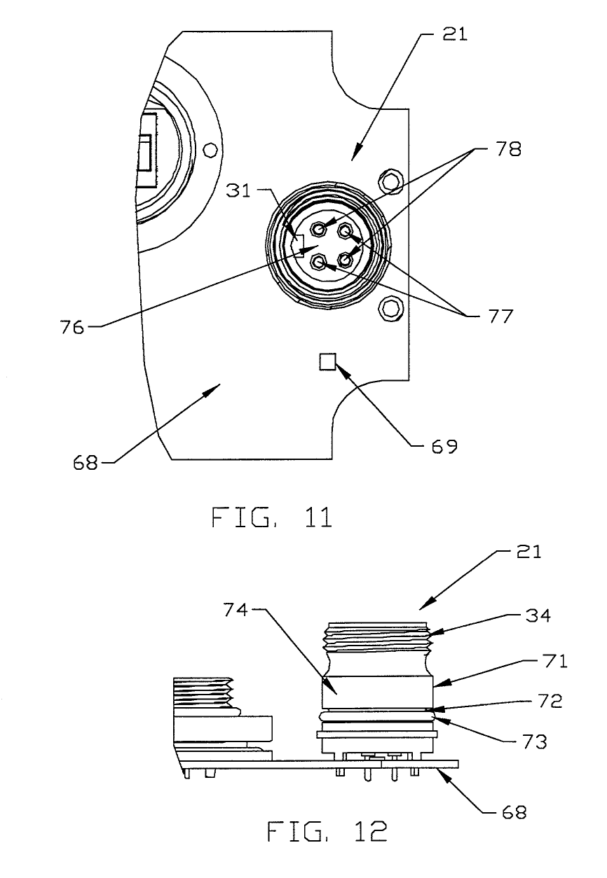

Turning now to the industrial parallel data connector 23, and referring first to FIG. 3, there is shown a perspective view of a protective receptacle or collet generally designated 38. The connector receptacle 38 is generally circular in its outer peripheral, and is molded of a rigid plastic, such as ABS, so that it provides a rugged, integral body resistant to external compressive forces, and forms a protective case for the conventional RJ45 connector designated 22 in FIG. 1 and shown at 40 in FIGS. 9 and 10.

The connector receptacle 38 includes a peripheral flange 43 which provides a shoulder 44 for engaging the undersurface of the top wall 20 of the housing 11. The connector receptacle 38 comprises a cylindrical sidewall 46 (FIG. 7) adjacent the peripheral flange 43 for forming the interference engagement with the top of housing 11. A peripheral groove 48 is formed in the top surface of the flange 43 of the receptacle and the top wall of the housing 11 (which is threaded at 42 in FIG. 7). The top of the cylindrical sidewall 46 is designated 49 in FIGS. 3 and 8, which forms an annular flat and receives a second O-ring 51 (FIG. 8) which seals against a coupling nut of a mating male industrial parallel data connector, such as that shown in U.S. patent application No. 09/660,051, filed Sep. 12, 2000 for “Data Signal Connector with Protective Overmold”, the subject matter of which is incorporated herein by reference. Above the O-ring 51 is an extension wall 52 of diameter less than the wall 46 and which is also externally threaded at 53 (FIG. 8) to receive a coupling nut of the mating male RJ45 connector. An internally threaded nut 50 (FIG. 6) is received on the lower, larger threads 42 of the wall 46. Thus, the connector receptacle 38 is secured in the switch housing 11 by the interference fit described and the nut 50. It is located relative to the housing 11 by means of the flange 43 and sealed to the housing 11 by the lower O-ring 47. The upper threaded extension 52 extends above the top wall 20 of the housing 11, as seen in FIG. 2; and O-ring 51 forms a seal between the connector receptacle 38 for the parallel data connector 23 and a conventional mating male connector (not shown).

Referring to FIGS. 3 and 4, the center of the connector receptacle 38 includes a generally rectangular central opening generally designated 54 for receiving the RJ45 connector 40 (FIG. 9). As seen in FIG. 8, on each side of the opening 54 there is a an elongated slot such as the ones designated 55 in FIG. 8. The slots 55 receive lateral protrusions on the RJ45 connector 40, and the slots 55 act to position the connector 40 within the connector receptacle 38 and limit its insertion so that the face of the connector, designated 60 in FIG. 9, is substantially flush with the front top surface 61 of the connector receptacle 38 until the connector is connected to the printed circuit board and secured by an epoxy filling of the casing.

Turning to FIGS. 3 and 4, the RJ45 connector typically is provided with a thin outer metallic sheathing not capable of resisting larger compressive forces, and which is primarily intended for the purpose of reducing radio frequency interference. Within the connector 40 are a plurality of connecting elements 63 (eight in number) which are laterally aligned to mate with corresponding connecting elements of a male RJ45 connector, as described above. The RJ45 female connector shown is thus described as an in-line parallel data connector.

Further, the connector receptacle 38 provides a lower recess 65 at the base of the opening 54 in the connector receptacle for accommodating, locating and protecting the elements of the RJ45 connector received therein.

As seen in FIGS. 11 and 12, a printed circuit board 68 may be mounted to the leads of the commercial Ethernet connector 40 held within the collet 44, and projecting through the rear of the collet. Individual leads from the printed circuit board 68 to a master printed circuit board housing the microprocessor, firmware and other circuitry to be disclosed, would all be embedded within the housing 11.

Returning now to FIGS. 1 and 2, it can be seen particularly from FIG. 2 that the top of the housing 11 is stepped, including the raised upper surface 20 in which the data signal connectors 12-19 and the quick disconnect power connector 21 are mounted. On the left side, a lower surface supports the industrial parallel data connector 23.

Each of the corners of the housing 11 is recessed, as at 65 in FIG. 1, and an aperture 66 is provided within the recessed portion 65 so that a mounting screw may be used to mount the housing 11 of the interconnect system to a surface to provide security, access and reliability, if desired.

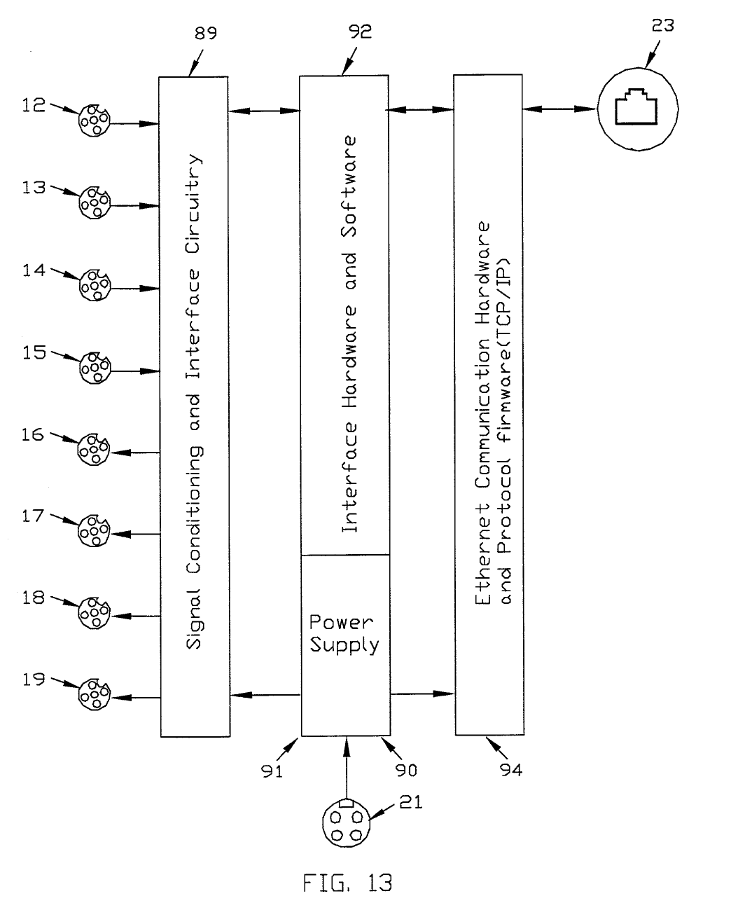

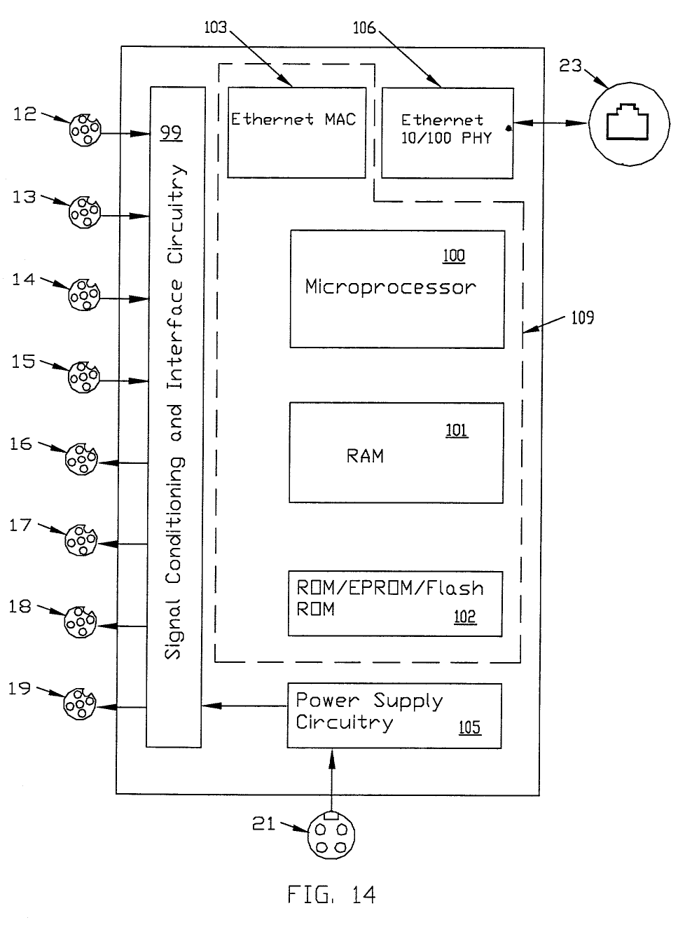

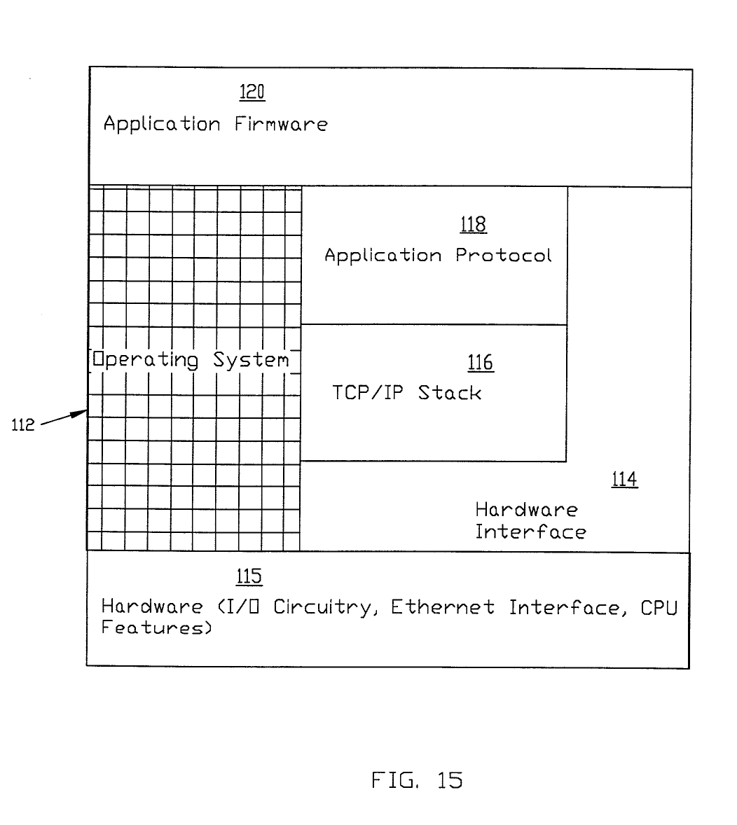

Turning now to FIG. 13, there is shown one embodiment of the master controller. The input data connectors are again numbered 12-15, in FIG. 9 and the output data connectors are designated 16-19. All of the input data signal connectors 12-15 as well as the output data signal connectors 16-19 are connected to conventional Signal Conditioning and Interface Circuitry shown schematically within the block 89 in FIG. 13. The quick disconnect power connector 21 is connected to a printed circuit board referred to as the client board for distributing power as indicated within the portion 90 of the block 91. Also included on the communication system client board, within the block 92, is Interface Hardware and stored Software, as will be further described. The power supply board 90 communicates both with the Signal Conditioning and Interface Circuitry 89, and Ethernet Communication Hardware and Protocol Firmware, shown diagrammatically within the block 94. The Interface Hardware and Software 92 communicates with both the Signal Conditioning and Interface Circuitry 89 as well as the Ethernet Communication Hardware and Protocol Firmware 94. The industrial data connector 23 communicates with the Ethernet Communication Hardware and Protocol Firmware 94, as seen in FIG. 13.

FIG. 13 shows one way in which hardware capable of implementing the invention may be configured. Other hardware configurations and other hardware combinations may equally well be employed in practicing the invention, as will be understood from the block diagram of FIG. 14 wherein reference numeral 99 indicates Signal Conditioning and Interface Circuitry associated with input/output from the serial data signal connectors 12-19 to a central processor in the form of a microprocessor 100. Random access memory necessary to store incoming and outgoing signals is provided by the RAM 101. Firmware including read only memory (ROM), EPROM and FLASH ROM are provided in block 102. An Ethernet media access controller (MAC) is provided in the block 103, and an Ethernet physical layer interface or PHY is provided in the block 104.

The Signal Conditioning and Interface Circuitry 99 interfaces the microprocessor 100 with the output serial data connectors 12-15 and the input serial data connectors 16-19. The required circuit techniques for interfacing incoming and outgoing data signals from the sensors and to the actuators with a microprocessor are well known in the industry. The power supply circuitry 105 supplies power to the various circuits as required, also employing conventional circuitry and circuit techniques. The Ethernet Physical Layer Interface 106 provides the necessary interface between the incoming and outgoing data passing through the industrial parallel data connector 23 and the specific Ethernet media being used in the interconnect system. For example, the Ethernet system may be a 10/baseT or a 100/baseT format. The Ethernet physical layer interface 106 is thus appropriately chosen using conventional technology.

The Ethernet media access controller (MAC) 103 is also conventional and separate chips are commercially available. It may be a stand-alone Ethernet chip, or it may be incorporated into a single-chip micro controller, such as schematically illustrated in FIG. 14 by block enclosed within the bold dotted line 109. The microprocessor 100 is programmed to execute the firmware stored in block 102. The ROM/EPROM/FLASH ROM firmware 102 again is known in the industry and commercially available for providing the necessary logical operations to interface the Ethernet formatted data with the digital signals being received serially from the input/output connectors 12-19.

Turning now to FIG. 15, there is shown a software block diagram for the disclosed interconnect system. The software includes an operating system shown within the block 112 which provides tasks such as scheduling, timing, management and allocation of memory, and similar routine housekeeping functions. A Hardware Interface block 114 controls the specific hardware included within the block 115 which is associated with the particular application. For example, the interface between the Ethernet network and the Input/Output Circuitry in block 115 is accomplished by the Hardware Interface Software 114.

The software identified as TCP/IP stack in block 116 accesses the Ethernet Media Access Controller 103 (FIG. 14) via the Hardware Interface Circuitry 114 and is employed whenever the particular application protocol uses the TCP/IP Suite. Otherwise, the stack 116 is not necessary. The function of the TCP/IP stack 116 is otherwise well known to those skilled in the art.

The Ethernet Media Access Controller 103 is a standard semi-conductor chip used to control the flow of transmitting and receiving Ethernet data via the industrial Ethernet connector 23 and the Ethernet Physical Layer Interface 106.

The Application Protocol Software, block 118 in FIG. 15, implements the specific data and control protocols supported by the end products being used. For example, ModBus/TCP, Ethernet/IP®, SMTP (e-mail), HTML, (web pages using hyper text media language) layered on top of the TCP/IP suite.

Application Firmware, block communicates on the Ethernet network via connector 23 using the Application Protocol 118 and controls the flow and routing of input/output data via the Hardware Interface 114.

The application layer communicates on the network via the industrial parallel data connector 23 using the Application Protocol 118, and controls the Input/Output Circuitry in the block 115 via the Hardware Interface, block 114.

The Ethernet Physical Layer Interface 106 (FIG. 14) interfaces to the physical parameters of the media being used, for example, the type of cable and connectors which are being used, for the specific Ethernet media being employed, for example, 10/BaseT twisted pair cable with RJ45 connectors, or 10/Base-FL fiber optic cable and fiber optic connectors.

TCP/IP Stack 116 accommodates a physical bit strain via an IP data packet in the media access controller 103. The IP data packet communicates with the network via a TCP data packet, and the TCP software is located in a file segment.

Persons skilled in the art will be able to implement a specific protocol for a specific media application.

Having thus disclosed in detail a preferred embodiment of the invention, persons skilled in the art will appreciate the equivalent elements may be substituted for those disclosed and the structure illustrated may be modified while continuing to practice the principle of the invention. It is, therefore, intended that all such substitutions and modifications be covered as they are embraced within this spirit and scope of the present invention.

1. An industrial multi-port data interconnect apparatus comprising:
a housing including a wall;
at least one industrial parallel data connector mounted to said housing, each parallel data connector including a receptacle of rigid non-conducting material defining an opening and an externally threaded extension extending outside of said housing; and a commercial parallel data connector received in said opening of said receptacle;
a sealing ring interposed between said receptacle and said wall of said housing;
a plurality of quick disconnect serial data connectors mounted to said housing and including an outer threaded portion, an insert of rigid non-conducting material, and a plurality of connecting elements carried by said insert;
a quick disconnect power connector mounted to said housing; and
a master controller within said housing and including a programmed data processor coupled to each of said plurality of serial data connectors and to said industrial parallel data connector and controlling the transmission of data between said parallel data connector and said plurality of serial data connectors.

2. The apparatus of claim 1 wherein said housing includes an upper wall and a bottom wall for support;
said upper wall including a portion in which said plurality of serial data connectors are mounted and said industrial parallel data connector is mounted.

3. The apparatus of claim 1 wherein said receptacle includes;
a peripheral flange for engaging said wall of said housing when said receptacle is assembled thereto;
said peripheral flange defining a circular groove opposing an underside of said wall of said housing; and
a sealing ring in said peripheral groove for forming a seal between said receptacle and said wall of said housing.

4. The apparatus of claim 3 wherein said receptacle further includes an annular flat extending adjacent said external threads of said extension; and
a second sealing ring adjacent said annular flat for sealing with a coupling nut of a mating connector.

5. The apparatus of claim 4 wherein said opening of said receptacle includes a generally rectangular cavity; and wherein said commercial parallel data connector comprises an RJ45 parallel data connector received in said cavity; and
at least a pair of opposing recesses for receiving projecting ears in locating said Ethernet connector relative to said receptacle.

6. The apparatus of claim 1 further comprising a printed circuit board within said casing, said quick disconnect power connector including a plurality of connecting pins coupled with said printed circuit board.

7. The apparatus of claim 6 wherein said quick disconnect power connector includes an exterior cylindrical wall defining a peripheral recess, said exterior wall extending through an aperture in an upper wall of said housing, said apparatus further including a third sealing ring in said peripheral recessed of said quick disconnect power connector for sealing with said housing.

8. The apparatus of claim 6 further comprising an LED indicator for signaling a first color when applied power is of proper polarity and a second color when applied power is reversed in polarity.

9. The apparatus of claim 1 wherein said plurality of serial data connectors includes at least one serial data connector having an insert of a first color, and at least one other serial data connector having an insert of a second color, readily discernible from said first color, whereby said one serial data connector is an input serial data connector and said other serial data connector is an output serial data connector.
